(19) United States
(12) Patent Application Publication
(10) Pub. No.: US 2009/0009855 A1
(43) Pub. Date: Jan. 8, 2009

(54) WIDE-BAND OPTICAL AMPLIFIER

(75) Inventors: Masahiro Nakatsuka, Osaka (JP); Yasushi Fujimoto, Osaka (JP); Young-Seok Seo, Osaka (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Japan Science and Technology Agency

(21) Appl. No.: 11/817,410

(22) PCT Filed: Feb. 28, 2006
(86) PCT No.: PCT/JP2006/303739

§ 371 Date: Aug. 30, 2007

(30) Foreign Application Priority Data
Mar. 4, 2005 (JP) 2005-059908

(51) Int. Cl. H01S 3/17

(52) U.S. Cl. 359/343

(57) ABSTRACT

There is provided a wide-band optical amplifying device capable of performing amplification over a wideband in infrared range. The wideband optical amplifier is characterized in that optical amplification is realized by optically exciting a glass or a crystal having bismuth as fluorescent center and that the amplification wavelength is 1000 nm to 1600 nm.

### TECHNICAL FIELD

The present invention relates to a wide-band optical amplification device. In particular, the present invention relates to a wide-band optical amplification device by means of bismuth fluorescence relevant to an optical communication, an optical fiber amplifier, a high optical power amplifier, a high power laser, and a laser oscillator.

### BACKGROUND ART

In recent years, luminescence in the infrared region was found from a Bi (Bismuth) doped silica glass. By use of this new type of fluorescence, it is expected to realize a wide-band amplifier and a wide-band laser oscillator including an optical fiber amplifier operating in the 1.3 μm optical information communication wavelength range.

On the other hand, an Er (erbium) doped fiber amplifier used in the optical communication has its amplification bandwidth in 1.55 μm region.

The zero-dispersion wavelength of the commonly used single mode silica fiber exists, however, in 1310 nm region, and an optical amplifier suitable to such wavelength region is limited only to a fluoride fiber such as Pr(praseodymium):ZBLAN. A problem of this fluoride is its sensitivity to environment conditions such as humidity. It is therefore desired to realize an amplifier in the band from 1000 nm to 1600 nm which is insensitive to environmental changes.

Furthermore, as for a high power laser, the output power of the laser using Nd (neodymium) as a fluorescent center is limited by the influence of the ESA (Excited-State Absorption).

[Patent document 1] Japanese Patent Publication No. 11-029334.
[Patent document 2] Japanese Patent Publication No. 2002-252397.
[Non-Patent document 1] K. Murata, Y. Fujimoto, M. Nakatsuka, T. Kanabe and H. Fujita, “Bi and SiO₂ as a new laser material for an intense laser”, Fusion Engineering and Design, 44 (1999), pp. 437-439.
[Non-Patent document 2] Y. Fujimoto, M. Nakatsuka, T. Omae, M. Yoshida and Y. Sudo “New luminescent properties of Bi doped silica glass in 1.3 μm range”, Journal of The Institute of Electronics, Information and Communication Engineering, C-I, Vol. J83-C, No. 4, (2000), pp. 354-355.
[Non-Patent document 3] Y. Fujimoto and M. Nakatsuka, “Luminescent properties in 1.3 μm range of Bi-doped silica glass by 0.8 μm range excitation and their application to optical communication”, Journal of The Institute of Electronics, Information and Communication Engineering, C-I, Vol. J84-C, No. 1, (2001), pp. 52-53.
[Non-Patent document 4] Y. Fujimoto and M. Nakatsuka, “Infrared fluorescence from bismuth doped silica glass”, Jpn. J. Appl. Phys., Vol. 40 (2001), No. 3B, pp. L279-L281.
[Non-Patent document 5] Y. Fujimoto and M. Nakatsuka, “Optical amplification in bismuth-doped silica glass”, Appl. Phys. Lett., 82 (2003), pp. 3325-3326.
[Non-Patent document 6] Y. Fujimoto, H. Matsubara and M. Nakatsuka, “A Fluorescence Spectrum at 1.3 μm of Bismuth-Doped Silica Glass with 0.8 μm Excitation”, CLEO/QELS'01, CWJ1, Baltimore Convention Center, USA, May 9, 2001, Technical Digest Series.
[Non-Patent document 7] Y. Fujimoto, H. Matsubara and M. Nakatsuka, “New Fluorescence from Bi-Doped Silica Glass and its 1.3-μm Emission with 0.8-μm Excitation for Fiber Amplifier”, CLEO/Pacific Rim 2001, Nippon Convention Center, Chiba, JAPAN, Jul. 15-19, 2001, Technical Digest Series.
[Non-Patent document 8] Y. Fujimoto and M. Nakatsuka, “New fluorescence at 1.3-μm with 0.8-μm excitation from Bi-doped silica glass”, CLEO/Europe-EQEC, 2003, CG8-2-FR1, 23-27 Jun., 2003, International Congress Center (ICM) Munich, Germany.
[Non-Patent document 9] Yasushi FUJIMOTO and Masahiro NAKATSUKA, “New fluorescence at 1.3-μm with 0.8-μm excitation from Bi-doped silica glass and its optical amplification”, XX International Congress on Glass, 0-07-077, Sep. 27-Oct. 1, 2004, Kyoto International Conference Hall, Kyoto, JAPAN.
[Non-Patent document 10] Shoichi KISHIMOTO, Masahiro TSUDA & Koichi SAKAGUCHI, Yasushi FUJIMOTO and Masahiro NAKATSUKA, “Novel bismuth-doped optical amplifier for 1.3-micron telecommunication band”, XX International Congress on Glass, 0-14-029, Sep. 27-Oct. 1, 2004, Kyoto International Conference Hall, Kyoto, JAPAN.

### DISCLOSURE OF INVENTION

Bi-doped silica glass has a silica glass as a main composition, but it exhibits a very broad fluorescence in the region from 1000 nm to 1600 nm. Making use of the characteristics, the present invention provides a wideband amplifier by configuring an optical amplifier in which this fluorescent material (including the optical fiber) is used. Since the main composition of this optical fiber is a silica glass, it withstands environmental changes. An optical amplification of this fiber only at a single wavelength of 1.3 μm has been confirmed as described in said non-patent document 5, and no demonstrations of the amplification have been made at any other wavelengths.

More specifically, this novel fluorescent material is processed into a bulk form or a fiber form in the present invention, and by superimposing an excitation light in the visible range with a wavelength tunable infrared probe light to be amplified in the sample, a wide band amplifying device in the infrared region is realized.

In view of the situation described above, the purpose of the present invention is to provide a wideband optical amplifying device capable of amplifying wideband signals in the infrared region.

In order to achieve the above objects, the present invention provides:
[1] a wideband optical amplifying device comprising an excitation light source, an amplifying medium composed of a glass or a crystal including bismuth as a fluorescent material, an optical coupler for a signal light and an excitation light, an isolator, and input and output ports.

[2] the wideband optical amplifying device described above in [1], characterized in that the optical amplification is realized in a wavelength range from 1000 nm to 1600 nm by using the glass or the crystal including bismuth as a fluorescent center and by an optical excitation.

[3] the wideband optical amplifying device described above in [1], characterized in that the wavelength range for amplification is from 1000 nm to 1600 nm and a plurality of wavelengths within this range can be simultaneously amplified.

[4] the wideband optical amplifying device described above in [1], characterized in that the wavelength range for amplification is from 1000 nm to 1600 nm, and a chirped light (a light pulse whose spectral wavelength is arranged in a time sequence) with ultra short pulses can be amplified.

[5] the wideband optical amplifying device described above in [1], characterized in that the wavelength range for amplification is from 1000 nm to 1600 nm, and a light from a source with a continuous wideband spectrum can be amplified.

[6] the wideband optical amplifying device described above in any one of [2] to [5], characterized in that the wavelength of the excitation light is from 400 nm to 1000 nm.

[7] the wideband optical amplifying device described above in any one of [2] to [5], characterized in that the wavelength of the excitation light lies in any one of the wavelength ranges of 500±100 nm, 700±100 nm, 850±100 nm, and 950±100 nm.

[8] the wideband optical amplifying device described above in any one of [2] to [5], characterized in that the excitation light has at least two or more wavelengths within the excitation wavelength range.

[9] the wideband optical amplifying device using the bismuth fluorescent material described above in [8], characterized in that the equalizing property of the amplification characteristics is at most 25% over a wavelength region from 1000 nm to 1400 nm.

[10] the wideband optical amplifying device described above in any one of [2] to [9], characterized in that the amplifying device is uses as a laser oscillator.

### BRIEF DESCRIPTION OF THE DRAWINGS

FIG. 1 shows a measurement apparatus for optical amplification to study wideband amplification characteristics for the Bi-doped silica glass in accordance with the present invention.

FIG. 2 shows a measurement result demonstrating a wideband gain characteristics of the Bi-doped silica glass in accordance with the present invention.

FIG. 3 is a configuration diagram of an experimental system of optical fiber amplification in accordance with the present invention.

FIG. 4 is a schematic diagram of a Bi-doped silica fiber in accordance with the present invention.

FIG. 5 is a schematic diagram of a coupling into a Bi-doped silica fiber in accordance with the present invention.

FIG. 6 shows an optical gain characteristics at a single wavelength (1308 nm) in accordance with the present invention.

FIG. 7 shows two wavelength amplification characteristics with an anchor wavelength of 1308 nm in accordance with the present invention.

FIG. 8 shows a fusion splicing of an optical fiber in accordance with the present invention.

FIG. 9 shows an experimental result of amplification obtained with a fusion spliced optical fiber amplification system in accordance with the present invention.

FIG. 10 is a schematic diagram of an experimental system of wideband amplification using a fusion spliced optical fiber amplification system in accordance with the present invention.

FIG. 11 shows a first experimental result (dependence upon excitation power) of amplification obtained with a fusion spliced optical fiber amplification system in accordance with the present invention.

FIG. 12 shows a second experimental result (dependence upon signal wavelength) of amplification obtained with a fusion spliced optical fiber amplification system in accordance with the present invention.

FIG. 13 is a configuration diagram of a wideband amplifier in accordance with the present invention.

FIG. 14 shows various excitation methods of a wideband amplifier in accordance with the present invention.

FIG. 15 shows flattened fluorescence spectra due to a two wavelength excitation in accordance with the present invention.

### BEST MODE FOR CARRYING OUT THE INVENTION

A wideband optical amplifying device using bismuth fluorescent material in accordance with the present invention is characterized in that an optical amplification is realized by optical excitation of a glass or a crystal having bismuth as a fluorescent center, and that a wavelength range for amplification is from 1000 nm to 1600 nm. Therefore, wideband amplification is realized, which makes a large capacity optical communication system feasible.

### Embodiments

Embodiments in accordance with the present invention are described in detail.

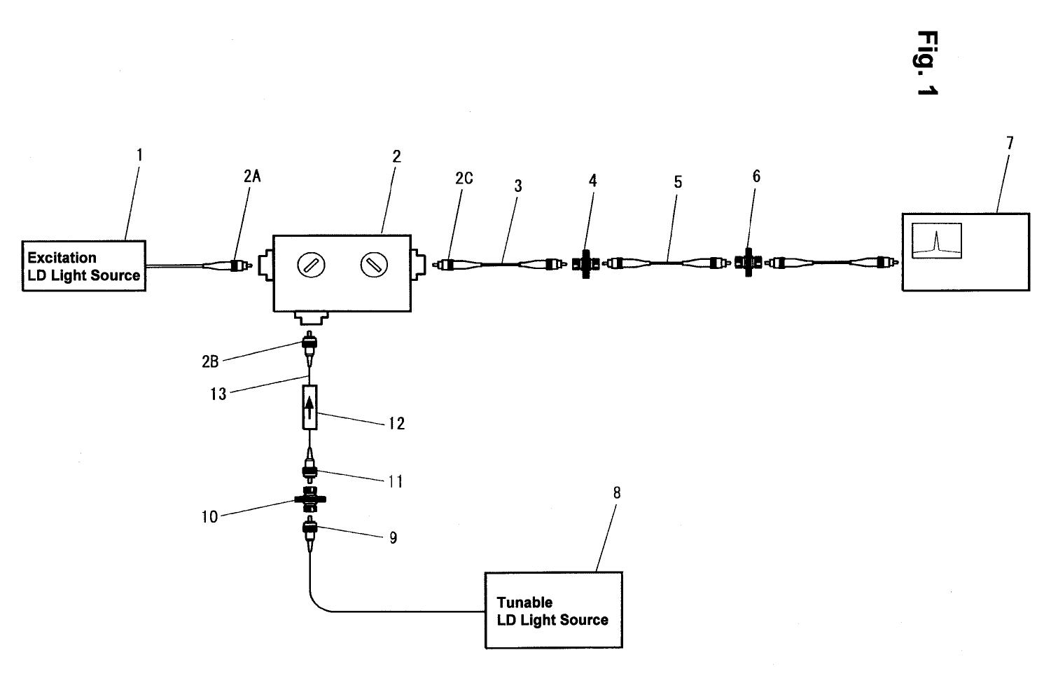

FIG. 1 shows a measurement apparatus for optical amplification to study wideband amplification characteristics for the Bi-doped silica glass in accordance with the present invention.

In this figure, 1 is an excitation LD light source (0.8 μm), 2 is a box of an optical system, 2A is its first input connector, 2B is its second input connector, 2C is its output connector, 3 is an optical fiber cable, 4, 6 and 10 are adaptors, 5 is a bismuth fiber (sample) with connectors attached, 7 is an optical spectrum analyzer, 8 is a wavelength tunable LD light source (1260 nm to 1360 nm) as a probe LD light source, 9 and 11 are FC type connectors with vertically polished faces, 12 is an optical isolator, and 13 is a single mode fiber.

Table 1 shows definitions of various measured values.

TABLE 1

| | excitation light | signal light | |
|---|---|---|---|
| A | off | off | measured value of |
| | | | background signal |
| B | Off | on | measured value of signal |
| | | | light (1.3 μm) |
| C | On | on | amplified output value |
| | | | (measured value of signal |
| | | | light plus excitation |
| | | | light) |
| D | On | off | excitation light passed |
| | | | through a sample (0.8 μm): |
| | | | laser output power: 0.0 W, |
| | | | 0.5 W, 1.0 W, 1.5 W, 2.0 W |

Table 1 shows definitions of measured values in the amplification signal measurement system.

Here, a case where the excitation LD light source 1 is off and the probe (signal) LD light source 8 is off is taken as a measured value of the background signal A, a case where the excitation LD light source 1 is off and the probe LD light source 8 is on is taken as a measured value of the signal light (1.3 μm) B, a case where the excitation LD light source 1 is on and the probe LD light source 8 is on is taken as an amplified output value C (measured value of signal light plus excitation light), and a case where the excitation LD light source 1 is on and the probe LD light source 8 is off is taken as an excitation light (0.8 μm) D passed through a sample (bismuth fiber with connectors attached) 5.

An optical amplification coefficient Gain is a ratio between an output light power and an incident light power, and is expressed by the following equation.

Gain=(C−D)/(B−A)=I/I₀ (1)

Here, I is an output light power, and I₀ is an incident light power. In addition, a gain coefficient g of a sample having thickness t is defined as follows.

g=(1/t)ln(I/I₀) (2)

A sample under test is a Bi-doped silica fiber 5 with connectors attached, which is made of a Bi-doped silica glass with Bi concentration of 0.5 mol %.

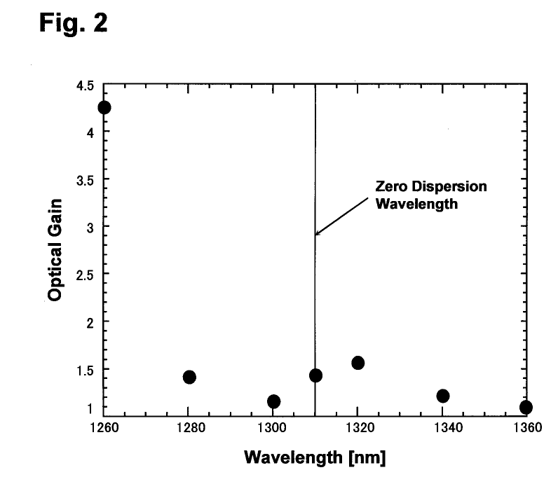

Here, the wavelength of the probe (signal) LD light source (wavelength tunable probe light source for amplification) 8 includes the zero dispersion wavelength 1310 nm in its tunable range, and is increased by a step of 20 nm from 1260 nm to 1360 nm. The amplified output light from the Bi-doped silica fiber with connectors attached 5 is measured. The result is shown in FIG. 2. In this measurement, the length of the Bi-doped silica fiber with connectors attached 5 was 24 cm, and an excitation power was 0.612 W. A very large gain was obtained at a fluorescence peak wavelength (1260 nm), and in addition, it is confirmed that the output power was amplified over the whole wavelength range. The fluorescence of the Bi-doped silica glass 5 is shown in the Patent Document 2 described above. From this result, it can be understood that the Bi-doped silica fiber (or glass) 5 provides gain in a wideband and operates as a wideband amplifier.

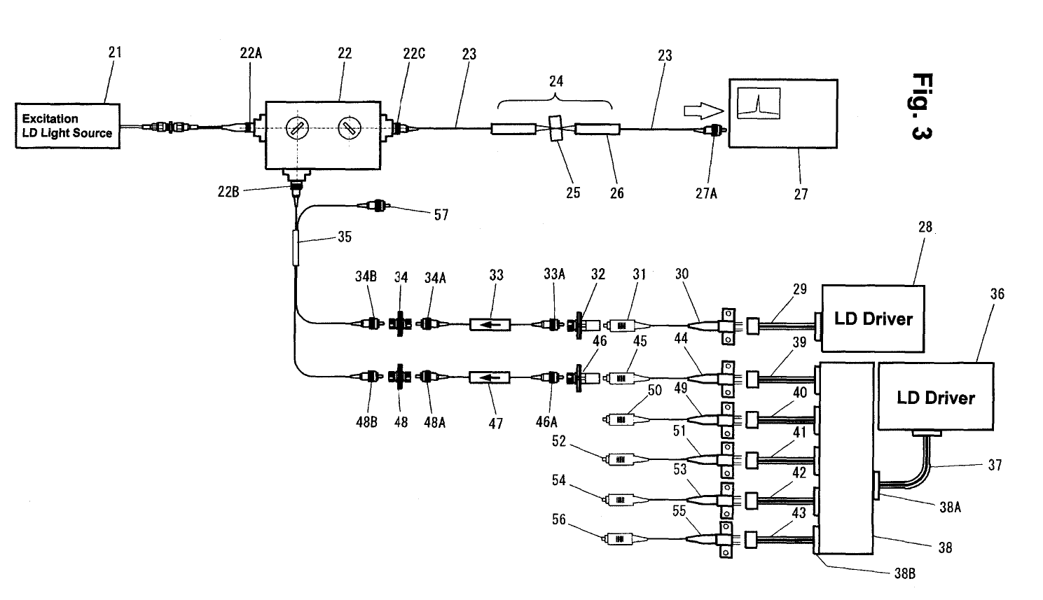

Subsequently, an amplification experiment was performed by using the Bi-doped silica optical fiber in accordance with the present invention. FIG. 3 is a configuration diagram of an experimental system of optical fiber amplification.

In this figure, 21 is an excitation LD light source (0.8 μm), 22 is a box of an optical system, 22A is its first input connector, 22B is its second input connector, 22C is its output connector, 23 is an optical fiber cable, 24 is a measuring system for a fiber or a bulk, 25 is an optical fiber (Bi-doped silica glass), 26 is an OFR focuser, 27 is an optical spectrum analyzer, 27A, 33A, 34A, 34B, 46A, 48A, 48B are connectors, 28 and 36 are LD drivers, 29, 37, 39 to 43 are device cables with connectors attached, 30 is a probe LD light source (1.3 μm), 31, 45, 50, 52, 54, and 56 are connectors (SC/PC), 32 and 46 are FC-SC transforming adaptors, 33 and 47 are isolators, 34 and 48 are FC-FC transforming adaptors, 35 is a fiber coupler, 38 is a device change-over box, 38A is its input terminal, 38B is its output terminal, 44 is a 1.272 μm LD light source, 49 is a 1.297 μm LD light source, 51 is a 1.307 μm LD light source, 53 is a 1.323 μm LD light source, 55 is a 1.347 μm LD light source, and 57 is a (FC/APC) connector for monitoring signals.

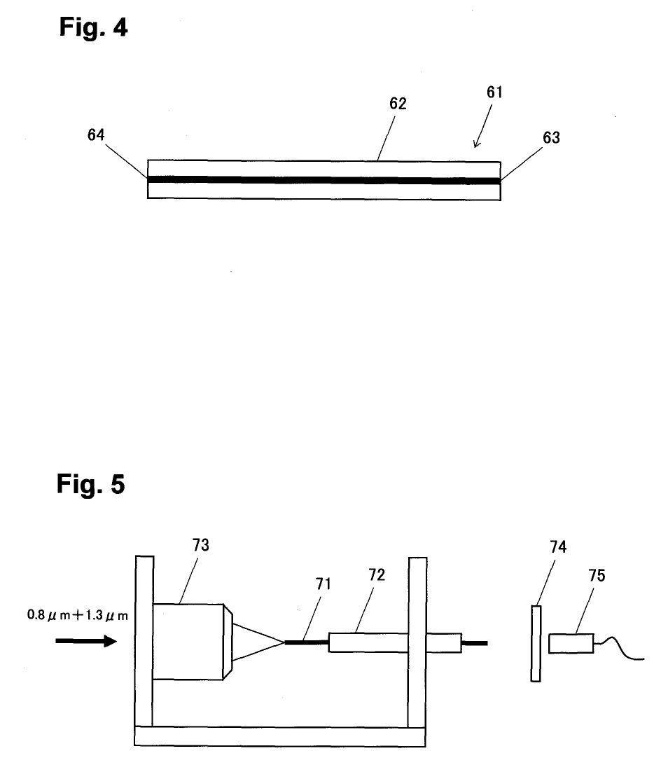

An optical fiber (Bi-doped silica glass) 25 used in this experiment was very fragile and easy to break. Therefore, as shown in FIG. 4, the surface of the optical fiber (Bi-doped silica glass) 61 was provided with Tefron™ resin coating 62 by using a spray type Tefron™ resin. In addition, both end surfaces 63 and 64 of the Bi-doped silica fiber 61 were cleaved and then manually polished. The length of the fiber used in the amplification experiment was 8 cm.

FIG. 5 is a schematic diagram of a method of a coupling into a Bi-doped silica fiber described above. As shown in this figure, the Bi-doped silica fiber 71 coated by the resin is fixed by a fiber chuck 72. A light from the excitation LD light source (0.8 μm) and a light from the probe LD light source (1.3 μm) were combined in the experimental system shown in FIG. 1, transformed into a free space light by using a collimator and introduced into the Bi-doped silica fiber 71 through an objective lens 73. On the exit side of the Bi-doped silica fiber 71 there are provided a filter 74 to cutoff the excitation light (0.8 μm) and a focuser 75, through which the amplified light was introduced into a detector (a spectrum analyzer)(not shown).

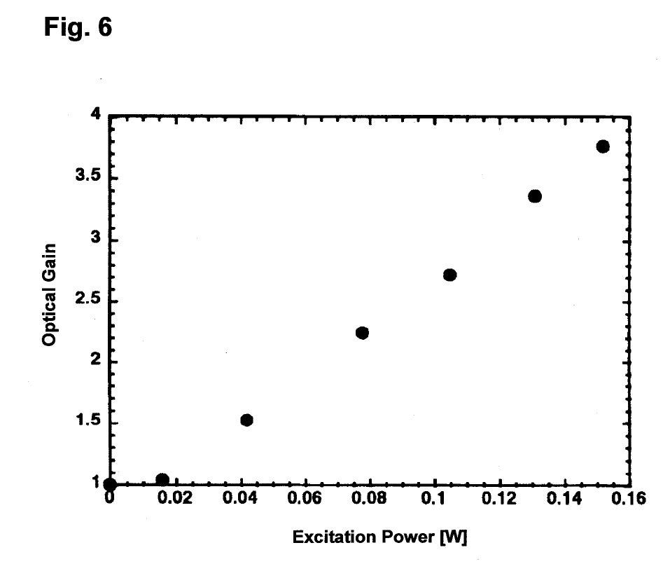

FIG. 6 shows an amplification characteristics at a single wavelength (1308 nm) obtained in this way. The horizontal axis shows the excitation power (W) incident on the objective lens. The vertical axis shows an obtained amplification factor. The maximum power output from the collimator was 152 mW, which was decreased to almost 25% of that (0.6 W) in the amplification experiment for a bulk glass. Nevertheless, the maximum amplification factor as high as 3.8 was obtained. In other words, it is understood that the confinement of the excitation light by the Bi-doped silica optical fiber is efficient. The gain coefficient in this case was 0.166 (cm⁻¹).

The core diameter of the Bi-doped silica fiber used in this case was 13 μm, and the core diameter of the fiber of the excitation light source used was 50 μm. Therefore, since light focusing of 50 μm or less can not be realized in principle, a coupling loss due to this must be taken into account. By reducing the coupling loss by means of fusion splicing for example, more efficient amplification system can be expected in the near future. In addition, since the power level of the excitation light source is reduced to a level of 100 mW, availability of a single mode excitation semiconductor laser, which is now used as an excitation light source of an amplifier for an optical communication and provides output power of about 100 mW in typical cases, can be positively considered. This will promote prospect in fabricating an amplifier for the optical communication significantly.

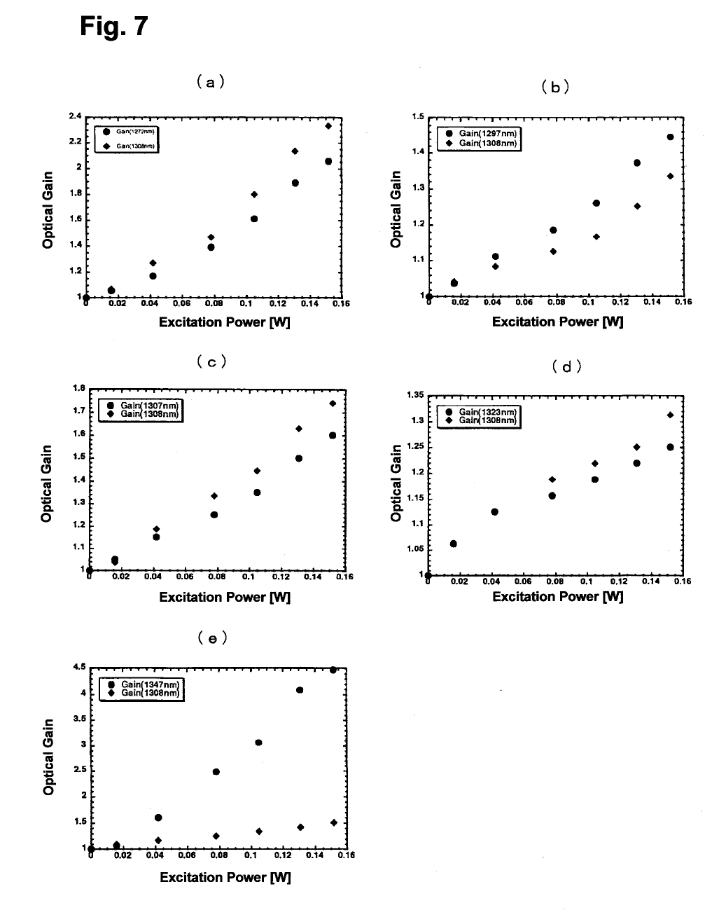

As an experiment of simultaneous amplification with multiple wavelengths, multiple amplification characteristics was measured with five wavelengths 1272 nm, 1297 nm, 1307 nm, 1323 nm, and 1347 nm with an anchor wavelength of 1308 nm. The results are shown in FIG. 7.

FIG. 7(a) shows a result of simultaneous amplification with two wavelengths 1272 nm and 1308 nm, FIG. 7(b) shows a result of simultaneous amplification with two wavelengths 1297 nm and 1308 nm, FIG. 7(c) shows a result of simultaneous amplification with two wavelengths 1307 nm and 1308 nm, FIG. 7(d) shows a result of simultaneous amplification with two wavelengths 1323 nm and 1308 nm, and FIG. 7(e) shows a result of simultaneous amplification with two wavelengths 1347 nm and 1308 nm.

As is clear from the previous results, it is understood that the simultaneous amplification with two wavelengths can be achieved by using the Bi-doped silica fiber. Fluctuations in optical gain between wavelengths is considered to come from the difference in coupling efficiencies (both on the incidence side and exit side) between different wavelengths in the case where the free space light is coupled. For example, by adjusting the coupling, the respective amplification factor changes. In any event, an improvement is expected, for example, by fusion splicing of the objective fibers.

The results described above show that fabrication of an amplifier with high efficiency is possible by an amplifier arrangement in the form of a fiber. Therefore, by reducing the loss by fusion splicing of the objective fibers using a fusion splicer, the development of higher efficient amplifier is expected. In addition, since the possibility to use an excitation light source with output power in a class of 100 mW is raised, the progress toward realization of a practical device has been made. As for the wavelength multiplexing amplification, two wavelength amplification was confirmed with bandwidth of 75 nm or more.

Next, a result of two wavelength amplification using a bulk glass is described. A sample used in the measurement is Bi₂O₃ (1.0 mol %), Al₂O₃ (7 mol %), SiO₂ (91.9 mol %), Tm₂O₃ (0.1 mol %). The sample surfaces are both polished to be perpendicular to the incident beam. The measurement system differs from that used in the case of a fiber amplification only in that the optical fiber (Bi-doped silica glass) 25 shown in FIG. 3 is replaced by a bulk sample. Prepared samples are 2.4 mm and 5.5 mm in thickness. The wavelength of the signal light is respectively, 1272 nm, 1297 nm, 1307 nm, 1323 nm, and 1347 nm. Output power of the excitation light with wavelength of 810 nm is 0.59 W. Table 2 shows gain of simultaneous amplification of two wavelengths at various wavelengths.

TABLE 2

| wavelength (nm) | Gain |
|---|---|
| 1308 | 1.29 |
| 1272 | 1.12 |
| 1308 | 1.37 |
| 1297 | 1.14 |
| 1308 | 1.37 |
| 1307 | 1.13 |
| 1308 | 1.30 |
| 1323 | 1.10 |
| 1308 | 1.19 |
| 1347 | 1.04 |

As can be seen from the table, simultaneous amplification at two wavelengths is demonstrated even when the bulk type glass is used. Amplification at multiple wavelengths is possible regardless of the fiber structure or the bulk structure.

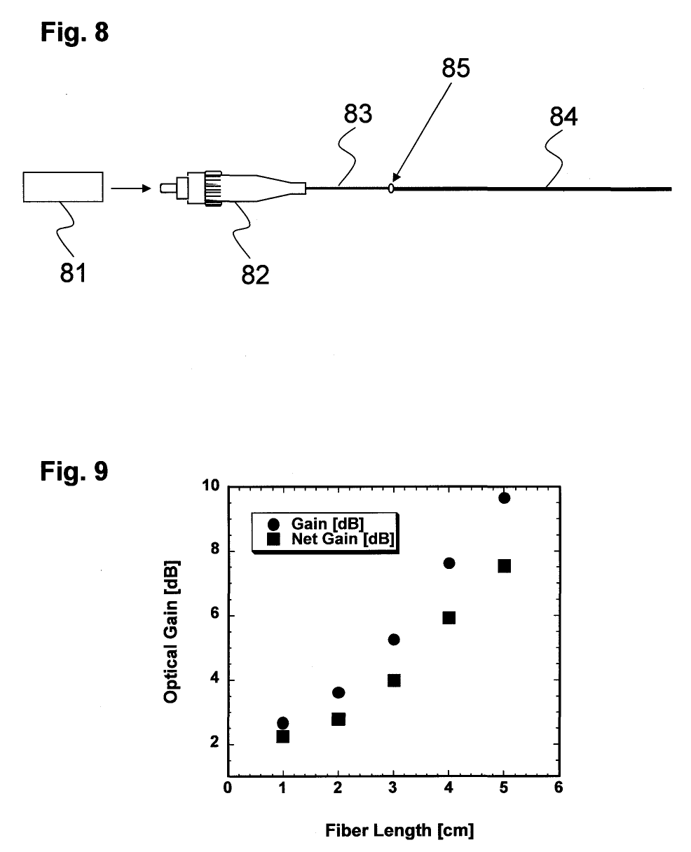

Next experiment was carried out by using a Bi-doped optical fiber with fusion splicing. The main part of the experimental apparatus is the same as the one shown in FIG. 3. Here, as shown in FIG. 8, a Bi-doped silica fiber 84 is fusion spliced at a splicing point 85 to a multimode fiber 83, and connected to the measuring system of fiber or bulk 24. The fiber core has a Bi₂O₃ concentration of 0.5 mol %. In FIG. 8, 81 is a light source for excitation and signal (0.8 μm excitation light source: 0.5 W, 1.3 μm LD light: 200-300 μW), 82 is a fiber coupler. Bi-doped silica fiber 84 is a single mode Bi-doped fiber (0.8 μm excitation light: 300 mW, 1.3 μm LD light: 200-300nW).

The Bi-doped silica fiber used here has a core-clad structure, and a core diameter is 9 μm. Since the LD light source for excitation and signal has an output form with a multimode (MM) fiber of 50 μm in core diameter, a silica MM fiber is used to splice the Bi-doped silica fiber. The measured result of the dependence of the amplification factor on the length of the optical fiber is shown in FIG. 9.

The excitation LD power derived into the optical fiber measured by the cut back method was 520 mW. It was 353 mW at a point 1 cm from the splicing point. After that, an attenuation of the excitation light of 15 mW per 1 cm each was observed. From this, a loss at the splicing point is estimated to be about 30%, or about 150 mW. Furthermore, the loss coefficient of the optical fiber at 1.3 μm wavelength band measured by the cut back method was 0.0977 cm⁻¹ (−42.4 dB/m). As shown in FIG. 9, gain at a fiber length of 5 cm is a factor of 9.25 (9.7 dB), and a net gain including a loss at the laser wavelength is a factor of 5.7 (7.5 dB). The fact that a net gain was obtained in this experiment is of great significance towards development of the practical device.

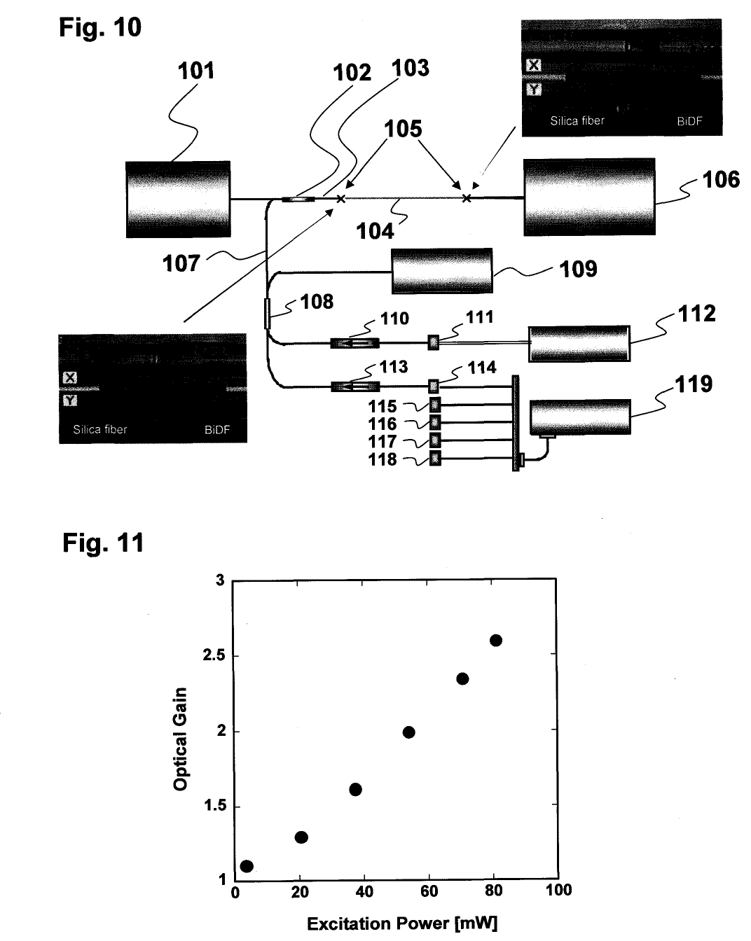

Subsequently, the following experiment was performed by arranging the Bi-doped silica fiber which was fusion spliced with single mode fibers at the both ends. Main part of the experimental apparatus is shown in FIG. 10. Bi₂O₃ concentration in the core of the fiber is 0.5 mol %. In FIG. 10, 101 is an excitation beam (845 nm LD), 102 is a fiber coupler, 103 is a single mode fiber, 104 is a Bi-doped silica fiber, 105 is a splicing point, 106 is an optical spectrum analyzer, 107 is a single mode fiber, 108 is a fiber coupler, 109 is an optical power meter, 110 and 113 are optical isolators, 111 is an LD (1308 nm), 112 and 119 are power supplies to LDs, 114 is an LD (1272 nm), 115 is an LD (1297 nm), 116 is an LD (1307 nm), 117 is an LD (1322 nm), and 118 is an LD (1347 nm).

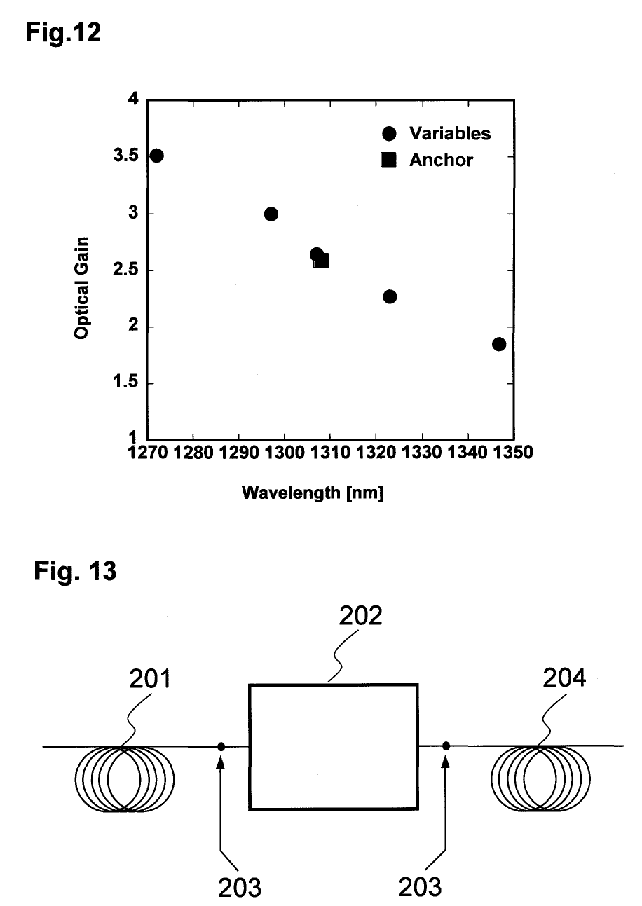

The Bi-doped silica fiber used here has a core-clad structure, and the core diameter is 9 μm. The fusion spliced fiber length was 5.5 cm. Since the LD light source for excitation (845 nm) has an output form with a single mode (SM) fiber, a silica SM fiber is used to splice with the Bi-doped silica fiber. The splicing part was shown in a photograph in FIG. 10. The measured result of the dependence of the optical gain on the excitation input power is shown in FIG. 11. Dependence of the optical gain on the signal wavelength when the excitation power is fixed at 81.4 mW is shown in FIG. 12.

Power of the excitation LD derivered into the optical fiber was measured 81.4 mW, which is about ⅙ of the excitation power when 9.7 dB of gain was obtained. From FIG. 11, obtained gain was a factor of 2.6 for the signal wavelength of 1308 nm. As clearly seen from FIG. 12, gain was obtained in the case of simultaneous amplification with two wavelengths in the wavelength range from 1270 nm to 1350 nm when the anchor wavelength was 1308 nm. This distribution is similar to the shape of the fluorescence spectrum.

As described above, the basic property with respect to a wideband amplifier using the Bi-doped silica glass has been measured, thereby leading to an expectation to realize a wideband amplifier in a wavelength range around 1.3 μm.

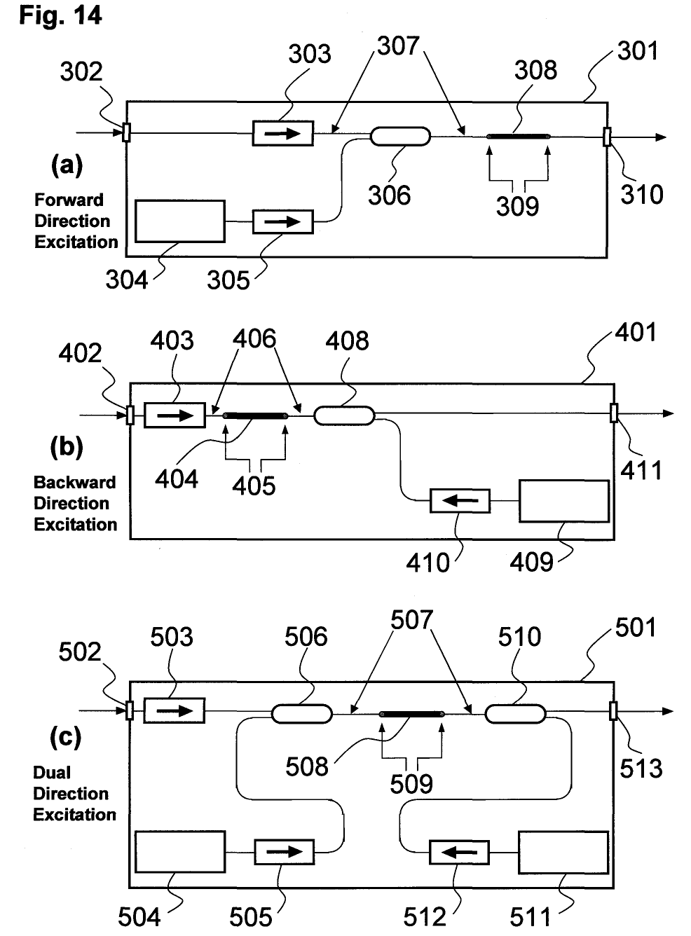

The basic configurations of a wideband amplifier based on the experimental results described above are shown in FIG. 13 and FIG. 14. In FIG. 13, 201 and 204 are single mode fibers (communication lines), 202 is a BiDFA (Bi-doped fiber amplifier), and 203 is a splicing point. Furthermore, in FIG. 14, FIG. 14 (a) shows a forward excitation case, and 301 is a first BiDFA (Bi-doped fiber amplifier), 302 and 310 are FC connectors, 303 and 305 are isolators, 304 is an excitation LD (500 nm, 700 nm, 800 nm, 940 nm), 306 is a WDM coupler (1.3 μm/0.8 μm), 307 is a single mode fiber, 308 is a BiDF (Bi-doped fiber), and 309 is a splicing point. FIG. 14(b) shows a backward excitation case, and 401 is a second BiDFA (Bi-doped fiber amplifier), 402 and 411 are FC connectors, 403 and 410 are isolators, 404 is a BiDF (Bi-doped fiber), 405 is a splicing point, 406 is a single mode fiber, 408 a WDM coupler (1.3 μm/0.8 μm), and 409 is an excitation LD (500 nm, 700 nm, 800 nm, 940 nm). FIG. 14(c) shows a dual direction excitation case, and 501 is a third BiDFA (Bi-doped fiber amplifier), 502 and 513 are FC connectors, 503, 505 and 512 are isolators, 504 and 511 are excitation LDs (500 nm, 700 nm, 800 nm, 940 nm), 506 and 510 are WDM couplers (1.3 μm/0.8 μm), 507 is a single mode fiber, 508 is a BiDF (Bi-doped fiber), 509 is a splicing point.

A feasibility to equalize the amplification characteristics is shown in the following. The Bi-doped silica glass has excitation wavelength regions of 500±100 nm, 700±100 nm, 850±100 nm and 950±100 nm, each having different fluorescence spectrum shape. By making use of at least two excitation wavelengths, a gain equalization can be expected.

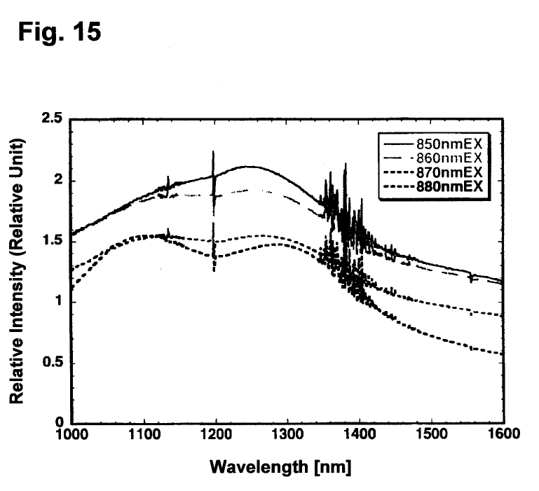

As shown in FIG. 15, by selecting the excitation wavelength in a region from 860 nm to 870 nm, an equalization of the amplification characteristics over 1000 nm to 1400 nm was realized where variation was suppressed to at most 25% or less. The Bi concentration in this case was 0.5 mol %. Although a single wavelength was used in this case for excitation, it corresponds to simultaneous excitation of two different excitation bands (850±100 nm and 950±100 nm). From this result, it is understood that a gain equalization can be realized by simultaneous excitation with two or more excitation wavelengths.

The equalization characteristics described above may be changed by a composition of the Bi-doped silica glass. Therefore, the excitation wavelength might be different for new composition, but it can be considered to lie within ±50 nm around 850 nm.

The two wavelength amplification was confirmed over a band width of 75 nm or more. This demonstrates that the Bi-doped silica fiber in accordance with the present invention can be operated as a wideband amplifier, has a function of simultaneous amplification at multiple wavelengths, and can realize a gain equalization by simultaneous excitation at two or more excitation wavelengths.

According to the present invention, an optical amplification over most of the band which is exhibited by the fluorescence spectrum of the Bi-doped silica glass is realized, and a wideband amplifier which will give the optical communication a larger capacity is realized. Furthermore the simultaneous optical amplification over a wideband will realize a function as an optical amplifier to amplify a chirped ultra short optical pulse. Due to this, it is possible to apply to various uses including a laser for processing, and a THz wave generation.

The present invention is not limited to the above-described embodiments, various modifications are possible based on the spirit of the invention. These modifications are not excluded from the scope of the invention.

### INDUSTRIAL APPLICABILITY

The wideband optical amplifying device in accordance with the present invention can be applied to optical communication, an optical fiber amplifier, a high power optical amplifier, a high peak power laser, and a laser oscillator.

1. A wideband optical amplifying device comprising an excitation light source of visible light and near infrared light, an amplifying medium composed of a glass or a crystal including bismuth as a fluorescent center, an infrared and wavelength tunable probe light source for amplification, an optical coupler to couple the excitation light of visible light and near infrared light with the infrared and wavelength tunable probe light for amplification, a first input port to connect the excitation light source of visible light and near infrared light to the optical coupler, an isolator connected to the infrared and wavelength tunable probe light source for amplification, a second input port to connect the isolator to the optical coupler, and an output port to connect the output side of the optical coupler to the amplifying medium, wherein the excitation light of visible light and near infrared light is superimposed with the infrared and wavelength tunable probe light for amplification within the amplifying medium, thereby realizing a wideband amplification in the infrared region.

2. The wideband optical amplifying device according to claim 1, characterized in that the optical amplification is realized in a wavelength range from 1000 nm to 1600 nm by using the glass or the crystal including bismuth as a fluorescent center and by an optical excitation.

3. The wideband optical amplifying device according to claim 1, characterized in that the wavelength range for amplification is from 1000 nm to 1600 nm and a plurality of wavelengths within this range can be simultaneously amplified.

4. The wideband optical amplifying device according to claim 1, characterized in that the wavelength range for amplification is from 1000 nm to 1600 nm, and a chirped light (a light pulse whose spectral wavelength is arranged in a time sequence) with ultra short pulses can be amplified.

5. The wideband optical amplifying device according to claim 1, characterized in that the wavelength range for amplification is from 1000 nm to 1600 nm, and a light with a continuous wideband spectrum can be amplified.

6. The wideband optical amplifying device according to any one of claims 2 to 5, characterized in that the wavelength of the excitation light is from 400 nm to 1000 nm.

7. The wideband optical amplifying device according to any one of claims 2 to 5, characterized in that the wavelength of the excitation light lies in any one of the wavelength ranges of 500±100 nm, 700±100 nm, 850±100 nm, and 950±100 nm.

8. The wideband optical amplifying device according to any one of claims 2 to 5, characterized in that the excitation light has at least two or more wavelengths within the excitation wavelength range claimed in claim 6 or 7.

9. The wideband optical amplifying device using the bismuth fluorescent material according to claim 8, characterized in that the equalizing property of the amplification characteristics is at most 25% over a wavelength region from 1000 nm to 1400 nm.

10. The wideband optical amplifying device according to any one of claims 2 to 9, characterized in that the amplifying device is used as a laser oscillator.
